(19) United States
(12) Patent Application Publication
(10) Pub. No.: US 2012/0193845 A1
(43) Pub. Date: Aug. 2, 2012

(54) COMPRESSOR AND AIR SUSPENSION APPARATUS USING THE SAME

(76) Inventor: Teruaki YAMANAKA, Ayase-shi (JP)

(21) Appl. No.: 13/353,868

(22) Filed: Jan. 19, 2012

(30) Foreign Application Priority Data
Jan. 31, 2011 (JP) 18311/2011

(51) Int. Cl. F16F 9/43; F04B 35/04

(52) U.S. Cl. 267/64.28; 417/415

(57) ABSTRACT

A compressor has a brush motor having a coil and brushes, a motor housing accommodating the brush motor, and a reciprocating compressor body in which a crank is rotationally driven by the brush motor to reciprocate a piston in a cylinder, thereby compressing a gas sucked in from a suction port and discharging the compressed gas from a delivery port. The compressor has a gas intake flow path configured such that the gas cools the brushes in the motor housing before cooling the coil and flowing to the suction port.

### BACKGROUND OF THE INVENTION

The present invention relates to a compressor configured to be installed in a vehicle, for example, a four-wheel automobile, and also relates to an air suspension apparatus using the compressor. More particularly, the present invention relates to a compressor suitably used for an air suspension or the like to supply and discharge compressed air for vehicle height control, and also relates to an air suspension apparatus using the compressor.

Generally, an air spring installed in a vehicle as a vehicle height controller is supplied with or exhausted of compressed air from a vehicle-mounted air compressor to suppress the change of vehicle height caused by a change in the weight of loaded vehicle, for example, and to properly adjust the vehicle height according to the driver's preference, for example.

The vehicle-mounted air compressor for supplying compressed air to the air spring drives a reciprocating compressor body with an electric motor to compress air sucked thereinto and supplies the compressed air to the air spring.

Japanese Patent Application Public Disclosure No. 2004-60524, for example, discloses an air compressor configured to suck air through the interior of an electric motor such that the air passes between a stator and rotor of the motor, thereby cooling the stator and the rotor.

In the air compressor of Japanese Patent Application Public Disclosure No. 2004-60524, the air flowing into the interior of the electric motor is passed through the gap between the stator and the rotor before being supplied to brushes that are in sliding contact with a commutator. Accordingly, the brushes are supplied with air raised in temperature by flowing through the gap between the stator and the rotor. Therefore, the brushes cannot effectively be cooled.

### SUMMARY OF THE INVENTION

An object of the present invention is to provide a compressor configured to actively cool the brushes raised in temperature, thereby making it possible to extend the service life of the brushes and to increase the operating time.

Another object of the present invention is to provide an air suspension apparatus using the compressor of the present invention.

To solve the above-described problem, the present invention provides a compressor having a gas intake flow path configured such that the gas cools the brushes in the motor housing before cooling the coil and flowing to the suction port.

### BRIEF DESCRIPTION OF THE DRAWINGS

FIG. 1 is a vertical sectional view of an air compressor according to a first embodiment of the present invention.

FIG. 2 is a side view of the air compressor in FIG. 1 as viewed from the right-hand side.

FIG. 3 is a sectional view of a crankcase, brushes, a partition (inlet openings), and so forth as seen from the direction of the arrow III-III in FIG. 1.

FIG. 4 is a front view showing the partition in FIG. 3 as a single component.

FIG. 5 is a sectional view as seen from the direction of the arrow V-V in FIG. 1, showing the way in which a metal pipe is attached to an air dryer.

FIG. 6 is a circuit diagram showing a structure for supplying compressed air from the air compressor to an air suspension.

FIG. 7 is a vertical sectional view of an air compressor according to a second embodiment of the present invention.

FIG. 8 is a sectional view as seen from the direction of the arrow VIII-VIII in FIG. 7, showing the relationship between an air dryer and a metal pipe.

FIG. 9 is a vertical sectional view of an air compressor according to a third embodiment of the present invention.

### DETAILED DESCRIPTION OF THE INVENTION

Compressors according to embodiments of the present invention will be explained below in detail with reference to the accompanying drawings by way of an example in which the present invention is used as a vehicle-mounted air compressor.

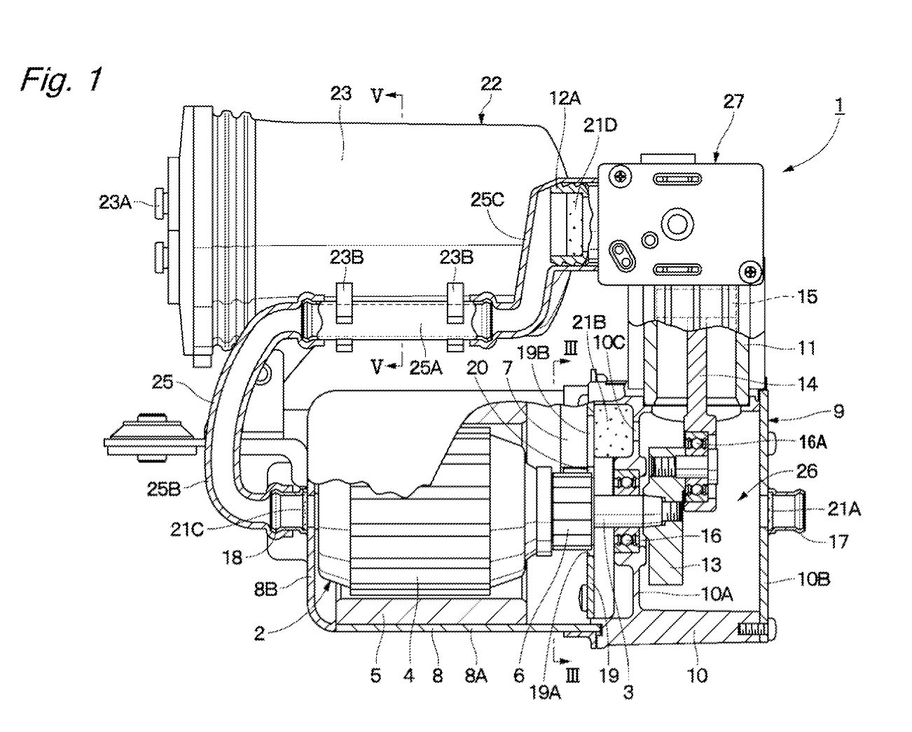

FIGS. 1 to 6 show a first embodiment of the present invention. In FIG. 1, a vehicle-mounted air compressor 1 includes a brush motor 2, a motor housing 8, a compressor body 9, an air dryer 22, and so forth, as described later.

The brush motor 2 is a power source of the air compressor 1. The brush motor 2 is provided in the motor housing 8 (described later). The brush motor 2 has a rotating shaft 3 rotatably supported at one end thereof by a crankcase 10 (described later). The other end of the rotating shaft 3 is rotatably supported by a bottom portion 8B of the motor housing 8. A rotor 4 serving as a coil is provided on an axially intermediate part of the rotating shaft 3. A stator 5 is provided around the outer periphery of the rotor 4 so as to face the rotor 4 across a gap. The stator 5 is made of a permanent magnet and secured to the inner surface of the motor housing 8.

A circular cylindrical commutator 6 is provided on one end portion of the rotating shaft 3. Four brushes 7 are provided around the commutator 6. The brushes 7 are secured to a partition 19 (described later). The four brushes 7 extend radially inward to press their respective distal ends against the commutator 6. In this state, the brushes 7 are circumferentially spaced from each other by 90 degrees. Thus, each brush 7 is fixedly disposed at a position facing one of inlet openings 19B of the partition 19 (described later). It should he noted that each brush 7 is radially movably provided and urged radially inward, i.e. toward the commutator 6.

The motor housing 8 accommodates the brush motor 2 and has a circular cylindrical portion 8A and a bottom portion 8B. The stator 5 is secured to the inner peripheral surface of the cylindrical portion 8A. The bottom portion 8B is provided with an outlet port 18 (described later). The opening end of the cylindrical portion 8A is secured to a crankcase 10 (described later).

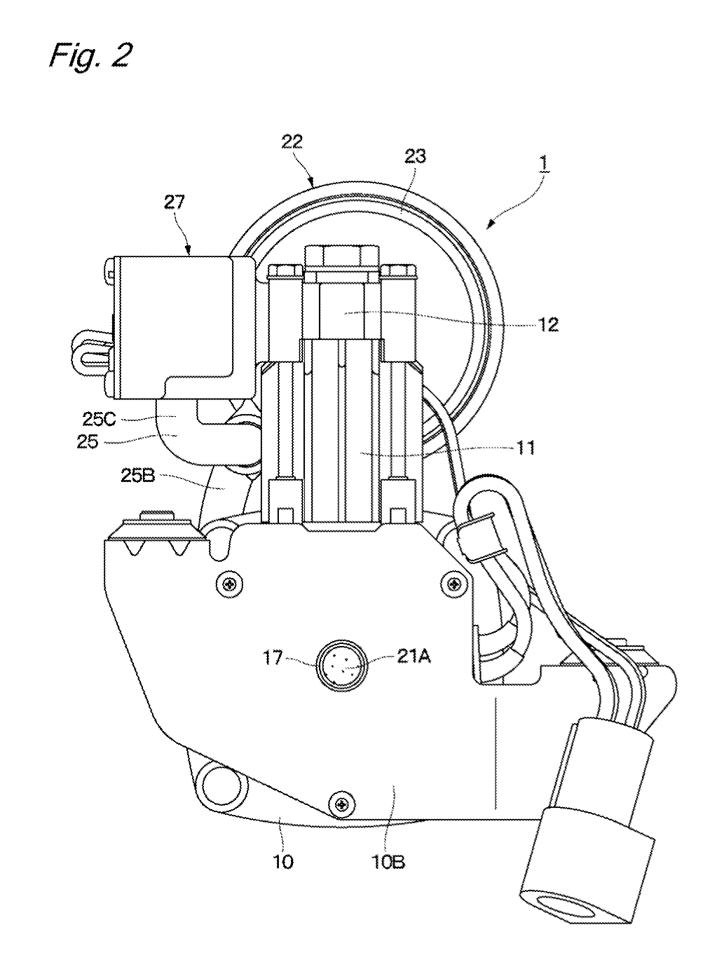

The compressor body 9 is driven by the brush motor 2 and provided at one end of the motor housing 8. The compressor body 9 includes a box-shaped crankcase 10, a cylinder 11 installed on the crankcase 10, a cylinder head 12 (see FIG. 2) installed on the cylinder 11, a crank 13 mounted on the one end of the rotating shaft 3 in the crankcase 10, a connecting rod 14 secured at the proximal end thereof to the crank 13, and a piston 15 secured to the distal end of the connecting rod 14 to reciprocate in the cylinder 11.

The crankcase 10 has one end serving as a bearing mounting surface 10A. A bearing 16 is mounted at a center position on the bearing mounting surface 10A to support the one end of the rotating shaft 3. The other end of the crankcase 10 is closed by a cover plate 10B. The cover plate 10B of the crankcase 10 has an intake port 17 (described later) provided substantially in the center thereof. The bearing mounting surface 10A is further provided with communicating holes 10C for allowing air flowing in through the intake port 17 to flow toward the brush motor 2. The communicating holes 10C are provided at four circumferentially spaced positions around the outer periphery of the bearing 16 so as to correspond to the four brushes 7.

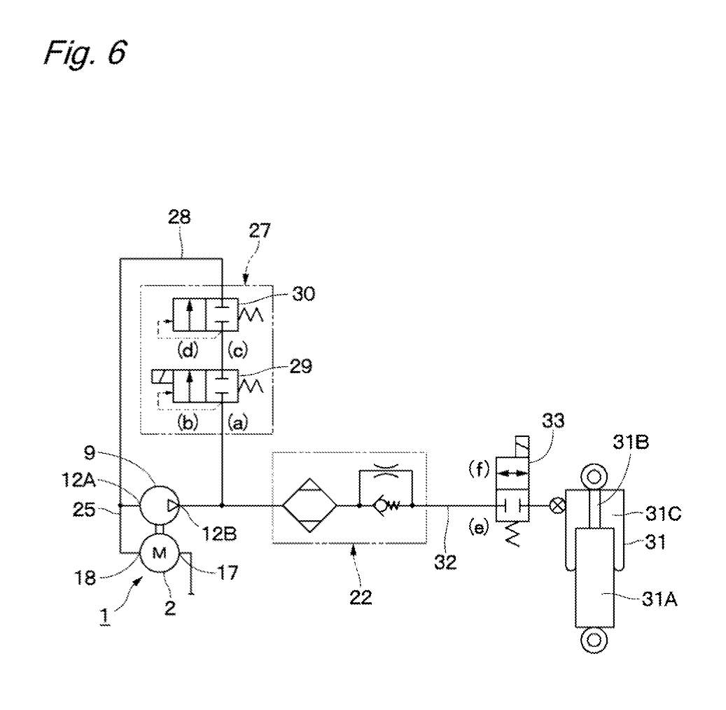

The cylinder head 12 is provided with an air suction port 12A and delivery port 12B (see FIG. 6). The suction port 12A is connected with a compressor-side hose 25C of connecting piping 25 (described later). The delivery port 12B is connected with an air dryer 22 (described later). The cylinder head 12 is provided with a suction valve and a discharge valve (which are not shown in the figures). The connecting rod 14 is rotatably attached at the proximal end thereof to an eccentric position of the crank 13 through a bearing 16A.

The intake port 17 is provided on the cover plate 10B of the crankcase 10 to serve as an opening for allowing the atmospheric air to flow into the crankcase 10. The structure in which the intake port 17 is provided on the cover plate 10B as in this embodiment has the following advantages. Air flowing into the motor housing 8 through the crankcase 10 first flows around the brushes 7, thereby enabling the brushes 7 to be cooled by the cool air. In addition, the substantially central portion of the cover plate 10B, where the intake port 17 is disposed, faces the bearings 16 and 16A. Therefore, the bearings 16 and 16A can be cooled by the air flowing in through the intake port 17.

On the other hand, the outlet port 18 is provided on the bottom portion 8B of the motor housing 8 to serve as an opening for discharging the air having flowed between the rotor 4 and the stator 5. Further, the outlet port 18 forms a joint to be connected with a motor-side hose 25B of the connecting piping 25 (described later).

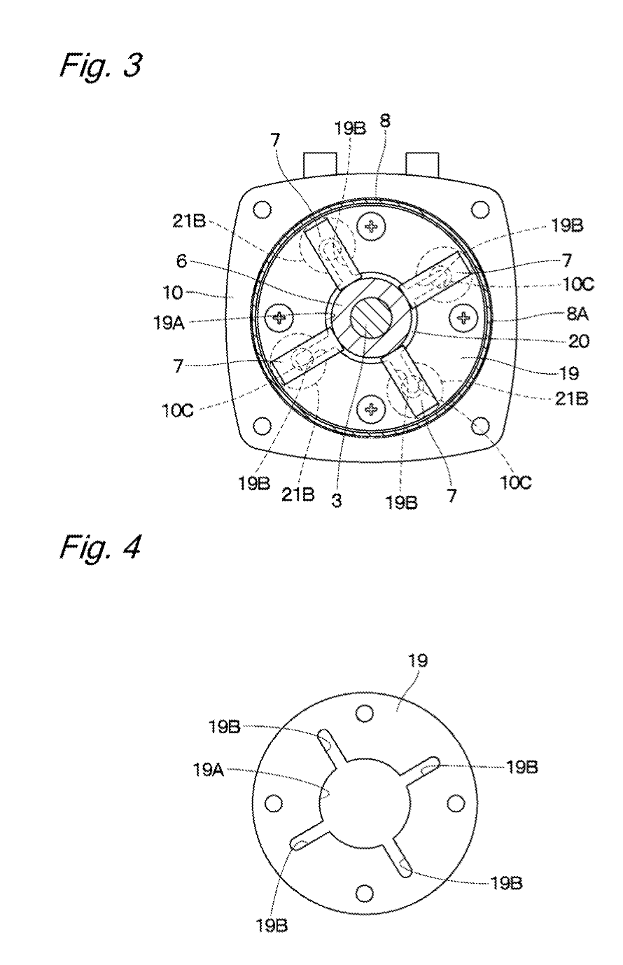

The partition 19 is provided between the motor housing 8 and the compressor body 9. As shown in FIGS. 3 and 4, the partition 19 is formed as an annular plate member having in the center thereof a round hole 19A larger in diameter than the commutator 6. The partition 19 is screwed to the bearing mounting surface 10A of the crankcase 10, for example. The central round hole 19A is formed larger in diameter than the commutator 6 so that an annular gap 20 is formed between the round hole 19A and the commutator 6. The gap 20 is used as a path of air (cooling air).

The partition 19 is provided with four cut groove-shaped inlet openings 19B extending radially outward from the round hole 19A. The outer ends of the four inlet openings 19B face the communicating holes 10C of the crankcase 10. The inlet openings 19B extend from the outer ends toward the round hole 19A along and opposite the four brushes 7. Each inlet opening 19B is formed so as to face a part of the overall length of the associated brush 7 that extends from the center to the distal end thereof. Thus, the inlet openings 19B actively allow the air to flow from the communicating holes 10C toward the gap 20 and to flow along the distal end portions of the brushes 7, which heat up to a high temperature by sliding contact with the commutator 6. The air having cooled the brushes 7 flows toward the rotor 4 through the surroundings of the brushes 7.

The intake port 17 is provided with a first filter 21A. A second filter 21B is provided between each communicating hole 10C (bearing mounting surface 10A) of the crankcase 10 and the associated inlet opening 19B of the partition 19. The outlet port 18 is provided with a third filter 21C. The suction port 12A of the cylinder head 12 is provided with a fourth filter 21D. The filters 21A to 21D are provided in front of and behind the brushes 7.

Thus, the filters 21A to 21D, when air is supplied to each air suspension 31 (described later), trap dust in the air flowing through an intake flow path 26 (described later) and allow clean air to be supplied to the air suspension 31. On the other hand, when discharged from the air suspension 31, the air is allowed to flow through the intake flow path 26 in the opposite direction to the above, thereby blowing off adhering dust from the filters 21A to 21D, and thus preventing clogging of the filters 21A to 21D with dust. The filters 21A to 21D are positioned to divide the crankcase 10, the motor housing 8, the connecting piping 25 and the cylinder head 12 from each other. Therefore, wear dust or the like produced in any of the divided spaces cannot flow out into another space.

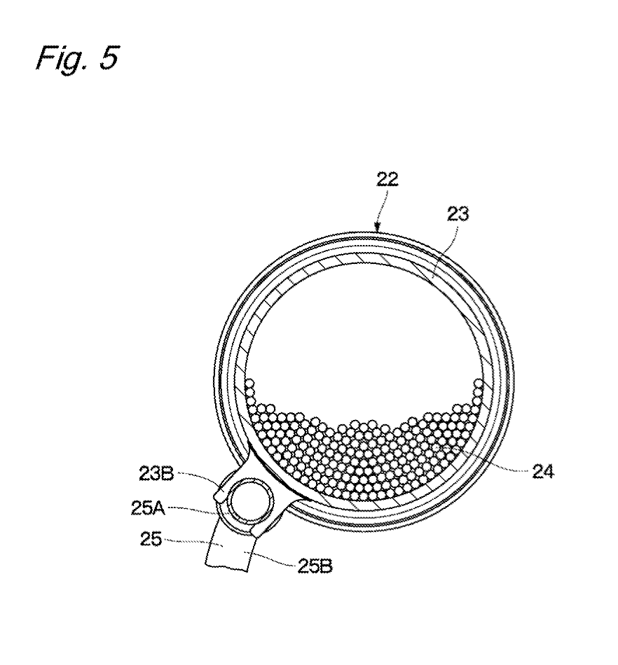

The air dryer 22 is provided in connection to the delivery port 12B of the cylinder head 12 and substantially comprises, as shown in FIG. 5, a dryer casing 23, which is a hollow closed container, and a water adsorbent 24 contained in the dryer casing 23. The water adsorbent 24 is a drying agent, e.g. silica gel. The dryer casing 23 of the air dryer 22 is connected at one end thereof to the delivery port 12B of the cylinder head 12. The air dryer 22 is disposed to extend parallel to the motor housing 8. The dryer casing 23 is provided at the other end thereof with a supply-discharge port 23A for supplying and discharging dry compressed air toward and from an air suspension 31 (described later). The supply-discharge port 23A is, as shown in FIG. 6, connected to a plurality of air suspensions 31 (only one of them is shown) through air piping 32 (described later) and so forth.

The dryer casing 23 is provided on the outer periphery thereof with two piping holders 23B at respective positions closer to the motor housing 8. As shown in FIGS. 1 and 5, the piping holders 23B are each formed in the shape of a C with resilience to pinchingly hold two axially opposite ends of a metal pipe 25A of connecting piping 25 (described later). The piping holders 23B secure the metal pipe 25A at a position close to the outer peripheral surface of the dryer casing 23 so that a slight gap is formed between the metal pipe 25A and the outer peripheral surface of the dryer casing 23. This structure prevents an individual from inserting a finger between the metal pipe 25A and the dryer casing 23 and thus makes it impossible to lift the air compressor 1 by holding the metal pipe 25A.

When compressed air is supplied toward the air suspensions 31 through the air dryer 22, the compressed air is brought into contact with the water adsorbent 24 in the air dryer 22 to adsorb and remove water from the compressed air, thereby allowing dry compressed air to be supplied toward the air suspensions 31. On the other hand, when compressed air is discharged from the air suspensions 31, dry compressed air flows backward through the dryer casing 23 to desorb water from the water adsorbent 24 so that the water adsorbent 24 is regenerated to be able to adsorb water.

The connecting piping 25 is provided to connect between the outlet port 18 of the motor housing 8 and the suction port 12A of the cylinder head 12 to supply air discharged from the outlet port 18 of the motor housing 8 toward the suction port 12A of the cylinder head 12. The connecting piping 25 uses a metal pipe as at least a part thereof. That is, the connecting piping 25 has a metal pipe 25A provided in a longitudinally intermediate part thereof. The metal pipe 25A is formed from a metallic pipe member. The connecting piping 25 further has a motor-side hose 25B serving as a motor-side universal joint connecting the outlet port 18 of the motor housing 8 and the metal pipe 25A, and a compressor-side hose 25C serving as a compressor-side universal joint connecting the metal pipe 25A and the suction port 12A of the cylinder head 12. The hoses 25B and 25C are each formed from a flexible rubber, resin or other similar hose to suppress the transmission of vibration.

The metal pipe 25A is secured by being pinchingly held with two piping holders 23B provided on the dryer casing 23. In this case, the metal pipe 25A is secured at a position close to the outer peripheral surface of the dryer casing 23. Accordingly, a human finger cannot be inserted between the metal pipe 25A and the dryer casing 23. It is therefore possible to prevent an individual from lifting the air compressor 1 by holding the metal pipe 25A. Moreover, because the metal pipe 25A has a high thermal conductivity, it is possible to efficiently dissipate heat from the air when flowing through the interior of the metal pipe 25A after being raised in temperature by cooling the brush motor 2 and so forth.

The intake flow path 26 is provided to extend through the compressor body 9, the brush motor 2 and the connecting piping 25 to provide a path for air to flow toward the suction port 12A of the cylinder head 12. More specifically, the intake flow path 26 comprises the intake port 17, the communicating holes 10C of the crankcase 10, the inlet openings 19B of the partition 19, the gap 20, the gap between the rotor 4 and the stator 5, the outlet port 18, and the connecting piping 25. The atmospheric air flows through these component parts of the intake flow path 26 in the order mentioned when compressed air is supplied to the air suspensions 31.

As shown in FIG. 6, a supply-discharge switching valve 27 is provided at the suction side of the cylinder head 12. The supply-discharge switching valve 27 substantially comprises a bypass pipeline 28 bypassing the compressor body 9 to connect the connecting piping 25 (the suction port 12A of the cylinder head 12) and one end of the air dryer 22 directly to each other. The supply-discharge switching valve 27 further comprises a two-way two-position air pilot electromagnetic on-off valve 29 provided on the bypass pipeline 28 and connected to a controller (not shown), and a two-way two-position air pilot on-off valve 30 provided in serial to the electromagnetic on-off valve 29 and switched to an “on” position (d) by switching the electromagnetic on-off valve 29 to an “on” position (b).

The electromagnetic on-off valve 29 is normally in an “off” position (a) to cut off the bypass pipeline 28. When supplied with a control signal from the controller, the electromagnetic on-off valve 29 is switched to the “on” position (b), and the on-off valve 30 is also switched to the “on” position (d), thereby enabling communication through the bypass pipeline 28.

The air suspensions 31 as vehicle-mounted air springs are each provided between a vehicle body-side member and a wheel-side member, which are not shown. In the case of a four-wheel vehicle, for example, a total of four air suspensions 31 are provided: two for the front wheels, and two for the rear wheels. Each air suspension 31 has an air chamber 31C between a cylinder 31A and a piston rod 31B. The air chamber 31C is connected through the air piping 32 to the supply-discharge port 23A of the dryer casing 23, which constitutes the air dryer 22. An air supply-discharge valve 33 is provided halfway on the air piping 32. The air supply-discharge valve 33 is a two-way two-position electromagnetic pilot on-off valve. The air supply-discharge valve 33 is normally in an “off” position (e) to cut off the air piping 32. When supplied with a control signal from the controller, the air supply-discharge valve 33 is switched to an “on” position (f) to enable communication through the air piping 32.

The following is an explanation of the operation of the air compressor 1 according to the first embodiment arranged as stated above, with regard to the flow of air when adjusting the height of the vehicle.

First, when the vehicle height is to be raised by the air suspensions 31, the brush motor 2 is driven to rotate the crank 13 of the compressor body 9 by a control signal from the controller. Consequently, the piston 15 of the compressor body 9 reciprocates in the cylinder 11 to compress air sucked in from the suction port 12A of the cylinder head 12 and to discharge the compressed air from the delivery port 12B.

More specifically, the air flows toward the suction port 12A of the cylinder head 12 as follows. The air intake flow path 26 is formed from the intake port 17, the communicating holes 10C of the crankcase 10, the inlet openings 19B of the partition 19, the gap 20, the gap between the rotor 4 and the stator 5, the outlet port 18, and the connecting piping 25, and the atmospheric air flows through these component parts of the intake flow path 26 in the order mentioned when compressed air is supplied to the air suspensions 31. Accordingly, air flowing into the crankcase 10 from the intake port 17 flows along the bearings 16 and 16A, thereby cooling the bearings 16 and 16A. It should be noted that the hearings 16 and 16A have a lower temperature rise than the brush motor 2 during operation of the air compressor 1; therefore, even the air passing through the bearings 16 and 16A can sufficiently cool the brush motor 2.

A part of the air passing through the bearings 16 and 16A passes through the communicating holes 10C of the crankcase 10 and flows to the inlet openings 19B of the partition 19. At the inlet openings 19B, the air flows along the brushes 7 from the center toward the distal end of each brush 7. Accordingly, the air having passed through the communicating holes 10C can actively cool the distal ends of the brushes 7, which heat up to the highest temperature in the motor housing 8 by sliding contact with the commutator 6, when the air flows from the inlet openings 19B into the gap 20 between the round hole 19A and the commutator 6.

The air having cooled the brushes 7 passes through the gap between the rotor 4 and the stator 5 and reaches the outlet port 18 after cooling the rotor 4 and the stator 5. At this time, the air having removed heat from the various parts of the air compressor 1 has a high temperature. However, when the air raised in temperature is supplied from the outlet port 18 to the suction port 12A through the connecting piping 25, the air can dissipate heat when flowing through the metal pipe 25A, which is provided halfway on the connecting piping 25, thereby enabling cool air to be supplied to the suction port 12A of the cylinder head 12. Thus, the compressor body 9 can efficiently compress air suppressed from thermal expansion. When the air flows through the air intake flow path 26, dust in the air can be trapped by the filters 21A to 21D arranged in a plurality of stages. Thus, clean air can be supplied to the air suspensions 31.

The compressed air discharged from the delivery port 12B of the cylinder head 12 is supplied to the air dryer 22, in which the air contacts the water adsorbent 24 in the dryer casing 23, thereby allowing water to be adsorbed by the water adsorbent 24 and thus providing dry compressed air.

The dry compressed air is supplied to the air chamber 31C of each air suspension 31 of the vehicle through the air piping 32 and the air supply-discharge valve 33 switched to the “on” position (f). Consequently, the air suspension 31 extends the piston rod 31B from the cylinder 31A to raise the height of the vehicle.

Next, the operation of the air compressor 1 to lower the height of the vehicle will be explained. First, the brush motor 2 is stopped to stop The operation of the compressor body 9. In this state, the electromagnetic on-off valve 29 is switched to the “on” position (b). Consequently, the on-off valve 30 is switched to the “on” position (d) to enable communication through the bypass pipeline 28.

Thus, the air discharged from the air chamber 31C of the air suspension 31 flows backward through the air piping 32 into the dryer casing 23 of the air dryer 22 to remove the adsorbed water from the water adsorbent 24 in the dryer casing 23 to regenerate the water adsorbent 24.

Thereafter, the air flowing out of the air dryer 22 passes through the bypass pipeline 28 and the on-off valve 29 to flow into the connecting piping 25. The air reaching the connecting piping 25 flows backward through the intake flow path 26, thereby blowing off adhering dust from the filters 21A to 21D to regenerate them. In addition, the flow of air through the motor housing 8 and the crankcase 10 enables various parts of the air compressor 1 to be cooled even when the air flows backward (when the air is discharged).

Thus, according to the first embodiment, the air flowing into the crankcase 10 from the intake port 17, which forms the intake flow path 26, cools the rotor 4 and the stator 5 after cooling the brushes 7. Accordingly, the brushes 7, which heat up to a high temperature in the motor housing 8, can be cooled actively by cool air, which has not yet been heated up.

As a result, the service life of the brushes 7 per se can be extended by actively cooling the brushes 7, which heat up to the highest temperature in the motor housing 8, and the heating of which has a significant effect also on the service life of the brush motor 2. The reduction in the thermal effect of the brushes 7 makes it possible to increase the period of time that the air compressor 1 can be operated continuously.

The partition 19 in the motor housing 8 is provided with inlet openings 19B at respective positions facing the brushes 7. Therefore, it is possible to surely cool the brushes 7, which heat up to a high temperature. Moreover, each inlet opening 19B is formed so as to face a part of the overall length of the associated brush 7 that extends from the center to the distal end thereof. Accordingly, the inlet openings 19B actively allow the air to flow toward the distal ends of the brushes 7, which heat up to a high temperature by sliding contact with the commutator 6. Thus, the brushes 7 can be cooled efficiently.

In addition, the gas intake flow path is provided with filters 21A to 21D in front of and behind the brushes 7. That is, the first filter 21 A is provided for the intake port 17. The second filter 21B is provided between each communicating hole 10C of the crankcase 10 and the associated inlet opening 19B of the partition 19. The third filter 21C is provided for the outlet port 18. The fourth filter 21D is provided for the suction port 12A of the cylinder head 12. With this structure, dust in the air can be trapped by the filters 21A to 21D, and clean air can be supplied to the air suspensions 31.

In addition, the filters 21A to 21D are positioned to divide the crankcase 10, the motor housing 8, the connecting piping 25 and the cylinder head 12 from each other. Therefore, wear dust or the like produced in any of the divided spaces cannot flow out into another space. Accordingly, it is possible to prevent abnormal wear or the like which would otherwise be caused by wear dust produced in the divided spaces and hence possible to improve durability also in this point of view.

Connecting piping 25 is provided to connect between the outlet port 18 of the motor housing 8 and the suction port 12A of the cylinder head 12. The connecting piping 25 has a metal pipe 25A formed from a metallic pipe member provided in a longitudinally central position of the connecting piping 25. The connecting piping 25 further has a flexible motor-side hose 25B connecting the outlet port 18 of the motor housing 8 and the metal pipe 25A, and a flexible compressor-side hose 25C connecting the metal pipe 25A and the suction port 12A of the cylinder head 12.

With the above-described structure, because the metal pipe 25A has a high thermal conductivity, it is possible to efficiently dissipate heat from the air when flowing through the interior of the metal pipe 25A after being raised in temperature by cooling the brush motor 2 and so forth, and hence possible to increase the air compression efficiency of the compressor body 9. In addition, the hoses 25B and 25C formed from flexible rubber, resin or other similar hoses can suppress the transmission of vibration, which allows an improvement in durability.

The metal pipe 25A of the connecting piping 25 is secured to the dryer casing 23 of the air dryer 22 provided in parallel to the motor housing 8. Accordingly, the connecting piping 25 can be provided stably so as not to swing considerably.

In addition, a slight gap is formed between the metal pipe 25A and the outer peripheral surface of the dryer casing 23. The gap is so small that a human finger cannot be inserted between the metal pipe 25A and the dryer casing 23. The small gap prevents an individual from holding the metal pipe 25A. Accordingly, it is possible to prevent an individual from carrying the air compressor 1 by holding the connecting piping 25.

In addition, when air is discharged from each air suspension 31 provided between a vehicle body-side member and a wheel-side member, the air is allowed to flow backward through the intake flow path 26, i.e. in the following order: the connecting piping 25, the outlet port 18, the gap between the rotor 4 and the stator 5, the gap 20, the inlet openings 19B of the partition 19, the communicating holes 10C of the crankcase 10, and the intake port 17. The air flowing backward can blow off adhering dust from the filters 21A to 21D and clean the filters 21A to 21D.

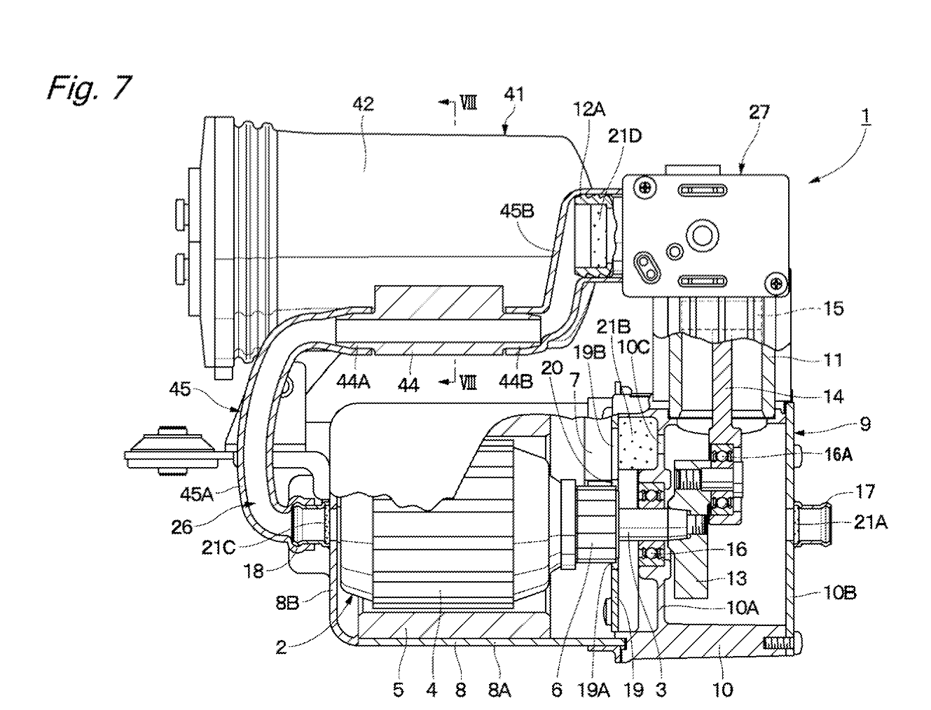

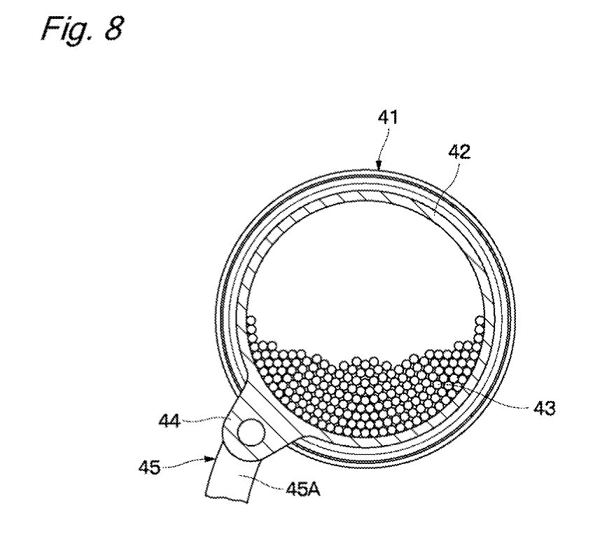

FIGS. 7 and 8 show a second embodiment of the present invention. The feature of this embodiment resides in that a metal pipe that forms connecting piping is integrally provided on an air dryer. It should be noted that, in this embodiment, the same constituent elements as those of the foregoing first embodiment are denoted by the same reference numerals as those used in the first embodiment, and a description thereof is omitted.

As shown in FIGS. 7 and 8, an air dryer 41 according to the second embodiment substantially comprises a dryer casing 42 and a water adsorbent 43 substantially in the same way as the air dryer 22 according to the foregoing first embodiment. The air dryer 41 according to this embodiment, however, differs from the air dryer 22 according to the first embodiment in that a metal pipe 44 (described later) is integrally provided on the dryer casing 42.

A metal pipe 44 is provided on the outer periphery of the dryer casing 42. The metal pipe 44 constitutes an intermediate part of connecting piping 45 (described later). As shown in FIG. 8, the metal pipe 44 is integrally formed with the dryer casing 42 formed as a circular cylindrical container by using a metal material. The metal pipe 44 extends in the axial direction of the dryer casing 42. The opposite end portions of the metal pipe 44 axially project to form a motor-side connecting port 44A and a compressor-side connecting port 44B, respectively.

Connecting piping 45 according to the second embodiment is provided to connect between the outlet port 18 of the motor housing 8 and the suction port 12A of the cylinder head 12 to supply air discharged from the outlet port 18 of the motor housing 8 toward the suction port 12A of the cylinder head 12. The connecting piping 45 uses a metal pipe in at least a part thereof. That is, the connecting piping 45 comprises the above-described metal pipe 44, which is provided in a longitudinally intermediate part of the connecting piping 45, a motor-side hose 45A as a motor-side universal joint connecting the outlet port 18 of the motor housing 8 and the motor-side connecting port 44A of the metal pipe 44, and a compressor-side hose 45B as a compressor-side universal joint connecting the compressor-side connecting port 44B of the metal pipe 44 and the suction port 12A of the cylinder head 12. The hoses 45A and 45B are each formed from a flexible rubber, resin or other similar hose to suppress the transmission of vibration.

Because the metal pipe 44 is integrally formed with the dryer casing 42, a human finger cannot be inserted between the metal pipe 44, which constitutes the connecting piping 45, and the dryer casing 42. Therefore, it is impossible for an individual to lift the air compressor 1 by holding the metal pipe 44. Moreover, because the metal pipe 44 has a high thermal conductivity, it is possible to efficiently dissipate heat from the air when flowing through the interior of the metal pipe 25A after being raised in temperature by cooling the brush motor 2 and so forth. Moreover, because the metal pipe 44 is integrally formed with the dryer casing 42, heat of the air that is transferred to the metal pipe 44 can be allowed to escape toward the dryer casing 42.

Thus, according to the second embodiment arranged as stated above, the metal pipe 44 is provided in the longitudinally central position on the connecting piping 45, and it is therefore possible to dissipate heat from the air raised in temperature by cooling the brush motor 2 and so forth, substantially in the same way as the foregoing first embodiment. Particularly, because the metal pipe 44 is integrally formed with the dryer casing 42, heat of the air that is transferred to the metal pipe 44 can be allowed to escape toward the dryer casing 42, and thus the circulating air can be cooled effectively. Consequently, the air compression efficiency of the compressor body 9 can be further increased. In addition, the hoses 45A and 45B formed from flexible rubber, resin or other similar hoses can suppress the transmission of vibration, which allows an improvement in durability. In addition, because the metal pipe 44 is integrally formed with the dryer casing 42, the installation strength of the metal pipe 44 can be increased, and it is also possible to carry the air compressor 1 by holding the metal pipe 44 with fingers.

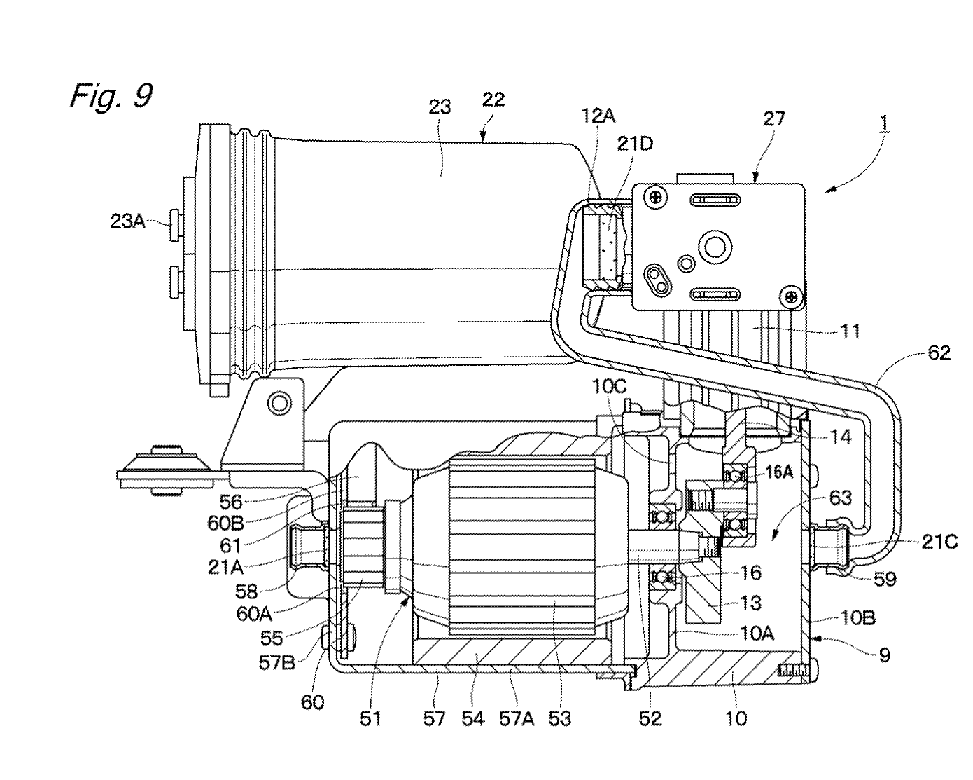

FIG. 9 shows a third embodiment of the present invention. The feature of this embodiment resides in that inlet openings are provided in the motor housing at a side thereof opposite to a side thereof at which the compressor body is installed. It should be noted that, in this embodiment, the same constituent elements as those in the foregoing first embodiment are denoted by the same reference numerals as those used in the first embodiment, and a description thereof is omitted.

In FIG. 9, a brush motor 51 according to the third embodiment has a rotating shaft 52 rotatably supported at one end thereof by the crankcase 10. The other end of the rotating shaft 52 is rotatably supported by a bottom portion 57B of a motor housing 57 (described later). A rotor 53 as a coil is provided on an axially intermediate part of the rotating shaft 52. A stator 54 is provided around the outer periphery of the rotor 53 to face the rotor 53 across a gap. The stator 54 is made of a permanent magnet and secured to the inner surface of the motor housing 57.

A circular cylindrical commutator 55 is provided on an end of the rotating shaft 52 remote from the compressor body 9, i.e. on the axially other end of the rotating shaft 52. Four brushes 56 (only one of them is shown) are provided around the commutator 55. The brushes 56 are secured to a partition 60 (described later). The four brushes 56 extend radially inward to press their respective distal ends against the commutator 55. In this state, the brushes 56 are circumferentially spaced from each other by 90 degrees. Thus, each brush 56 is fixedly disposed at a position facing one of inlet openings 60B of the partition 60 (described later). It should be noted that each brush 56 is radially movably provided and urged toward the commutator 55.

The motor housing 57 accommodates the brush motor 51 and has a circular cylindrical portion 57A and a bottom portion 57B. The stator 54 is secured to the inner peripheral surface of the cylindrical portion 57A. The bottom portion 57B is provided with an intake port 58 (described later). The opening end (one end) of the cylindrical portion 57A is secured to the crankcase 10.

The intake port 58 is provided on the bottom portion 57B of the motor housing 57 to serve as an opening for allowing the atmospheric air to flow into the motor housing 57. Providing the intake port 58 on the bottom portion 57B allows air flowing into the motor housing 57 to flow first around the brushes 56. Accordingly, the brushes 56 can be cooled with cool air.

An outlet port 59 is provided on the cover plate 10B of the crankcase 10 to serve as an opening for discharging air having flowed between the rotor 53 and the stator 54 and through the bearings 16 and 16A. Further, the outlet port 59 forms a joint to which connecting piping 62 (described later) is connected.

A partition 60 according to the third embodiment is provided in the motor housing 57 at a side thereof opposite to a side thereof at which the compressor body 9 is installed. That is, the partition 60 is provided in the motor housing 57 at a position facing the bottom portion 57B. The partition 60 has substantially the same structure as the partition 19 according to the first embodiment. That is, the partition 60 has in the center thereof a round hole 60A larger in diameter than the commutator 55 and further has four cut groove-shaped inlet openings 60B (only one of them is shown) extending radially outward from the round hole 60A. An annular gap 61 is formed between the round hole 60A and the commutator 55.

The four inlet openings 60B provided in the partition 60 are each formed so as to face a part of the overall length of the associated brush 56 that extends from the center to the distal end thereof. The inlet openings 60B actively allow the air to flow along the brushes 56 toward the distal end portions thereof, which heat up to a high temperature. The air having cooled the brushes 56 flows toward the rotor 53 through the surroundings of the brushes 56.

Connecting piping 62 according to the third embodiment is provided to connect between the outlet port 59 of the crankcase 10 and the suction port 12A of the cylinder head 12 to supply air discharged from the outlet port 59 toward the suction port 12A of the cylinder head 12. The connecting piping 62 is formed by bending a flexible rubber, resin or other similar hose into a substantially S-shape, for example. One end of the connecting piping 62 is connected to the outlet port 59 of the crankcase 10. The other end of the connecting piping 62 is connected to the suction port 12A of the cylinder head 12.

An intake flow path 63 extends through the brush motor 51, the compressor body 9 and the connecting piping 62 and comprises the intake port 58, the inlet openings 60B of the partition 60, the gap 61, the gap between the rotor 53 and the stator 54, the communicating holes 10C of the crankcase 10, the outlet port 59, and the connecting piping 62. The atmospheric air flows through these component parts of the intake flow path 63 in the order mentioned when compressed air is supplied to the air suspensions 31.

The following is an explanation of the operation of the air compressor 1 according to the third embodiment arranged as stated above, with regard to the flow of air when adjusting the height of the vehicle.

First, when the vehicle height is to be raised by the air suspensions 31, the brush motor 51 is driven to rotate the crank 13 of the compressor body 9 by a control signal from the controller. Consequently, the piston 15 of the compressor body 9 reciprocates in the cylinder 11 to compress air sucked in from the suction port 12A of the cylinder head 12 and to discharge the compressed air from the delivery port 12B.

More specifically, the air flows toward the suction port 12A of the cylinder head 12 as follows. The air intake flow path 63 is formed from the intake port 58, the inlet openings 60B of the partition 60, the gap 61, the gap between the rotor 53 and the stator 54, the communicating holes 10C of the crankcase 10, the outlet port 59, and the connecting piping 62, and the atmospheric air flows through these component parts of the intake flow path 63 in the order mentioned when compressed air is supplied to the air suspensions 31. Accordingly, air flowing into the motor housing 57 from the intake port 58 can cool the brush motor 51 sufficiently.

That is, the air flowing into the motor housing 57 from the intake port 58 flows to the inlet openings 60B of the partition 60. At the inlet openings 60B, the air flows along the brushes 56 from the center toward the distal end of each brush 56. Accordingly, the air having passed through the intake port 58 can actively cool the distal ends of the brushes 56, which heat up to the highest temperature in the motor housing 57 by sliding contact with the commutator 55, when the air flows from the inlet openings 60B into the gap 61 between the round hole 60A and the commutator 55.

The air having cooled the brushes 56 passes through the gap between the rotor 53 and the stator 54 and around the bearings 16 and 16A and reaches the outlet port 59 after cooling the rotor 4, the stator 5 and the bearings 16 and 16A. Thereafter, the air is supplied to the suction port 12A of the cylinder head 12 through the connecting piping 62. Thus, the compressor body 9 can compress the supplied air and discharge the compressed air from the delivery port 12B of the cylinder head 12.

The compressed air discharged from the delivery port 12B of the cylinder head 12 is supplied to the air chamber 31C of each air suspension 31 of the vehicle through a circulation path similar to that in the foregoing first embodiment. Consequently, the air suspension 31 extends the piston rod 31B from the cylinder 31A to raise the height of the vehicle.

Next, when the height of the vehicle is lowered, the compressed air flowing out of the air chamber 31C is made to bypass the compressor body 9 and to flow from the air dryer 22 directly into the connecting piping 62, thereby allowing the air to flow backward through the intake flow path 63 so as to be discharged to the outside. At this time also, the air flows through the crankcase 10 and the motor housing 57, thereby enabling various parts of the air compressor 1 to be cooled even when the air flows backward (when the air is discharged).

Thus, the third embodiment arranged as stated above can also provide substantially the same advantageous effects as those of the foregoing first embodiment. Particularly, according to the third embodiment, even in a case where the commutator 55 and the brushes 56, which rise in temperature during operation of the air compressor 1, are disposed in the motor housing 57 at a side thereof opposite to a side thereof at which the compressor body 9 is installed, i.e. in the bottom portion 57B of the motor housing 57, the commutator 55 and the brushes 56 can be actively cooled with cool air by providing the intake port 58 in the bottom portion 57B.

As a result, the service life of the brushes 56 per se can be prolonged. The reduction in the thermal effect of the brushes 56 makes it possible to increase the period of time that the air compressor 1 can be operated continuously. Because the inlet openings 60B are provided in the partition 60 at respective positions facing the brushes 56, it is possible to surely cool the brushes 56, which heat up to a high temperature.

It should be noted that, in the first embodiment, the present invention has been explained by way of an example in which the air compressor 1 is used to supply compressed air to the air chamber 31C of each air suspension 31 of the vehicle. The present invention, however, is not limited thereto. For example, the air compressor 1 may be used to supply and discharge compressed air to and from a pneumatic device such as an air cylinder, or an air tank. This structure is similarly applicable to the other embodiments.

Further, in the first embodiment, the present invention has been explained by way of an example in which the connecting piping 25 is provided with hoses 25B and 25C as universal joints, which are made of a flexible rubber, resin or other similar material. The present invention, however, is not limited thereto. Bellows-shaped metal pipes or the like may be used as universal joints of the connecting piping. This structure is similarly applicable to the other embodiments.

Further, in the first embodiment, the present invention has been explained by way of an example in which the partition 19 is attached to the crankcase 10. The present invention, however, is not limited thereto. For example, the partition may be attached to the motor housing. The partition may be integrally provided on the crankcase or the motor housing. This structure is similarly applicable to the second embodiment.

Further, in the third embodiment, the present invention has been explained by way of an example in which the outlet port 59 of the crankcase 10 and the suction port 12A of the cylinder head 12 are connected to each other by single connecting piping 62 formed from a flexible rubber, resin or other similar hose. The present invention, however, is not limited thereto. A metal pipe may be provided in a part of the connecting piping 62.

The following is an explanation of inventions included in the foregoing embodiments. In the present invention, the motor housing is provided with inlet openings for introducing a gas into the motor housing, and the brushes are secured at respective positions facing the inlet openings. With this structure, cool air before cooling the coil can be supplied to the brushes by passing the air through the inlet openings. Accordingly, it is possible to surely cool the brushes, which heat up to a high temperature.

According to one embodiment of the present invention, the inlet openings are provided in a partition between the motor housing and the compressor body. With this structure, the inlet openings can be readily provided simply by disposing the partition between the motor housing and the compressor body. By passing air through the inlet openings, the compressor body can also be cooled.

According to one embodiment of the present invention, the inlet openings are provided in the motor housing at a side thereof opposite to a side thereof at which the compressor body is installed. With this structure, the present invention can he applied also to a structure in which brushes of a brush motor are disposed in the motor housing at a side thereof remote from the compressor body. In addition, cool air that has just flowed in from the outside can be supplied to the brushes first. Thus, the brush cooling action can be enhanced.

According to one embodiment of the present invention, the gas intake flow path is provided with filters in front of and behind the brushes to trap dust in the gas. With this structure, it is possible to trap dust in the gas flowing through the motor housing and to supply clean gas toward the compressor body.

According to one embodiment of the present invention, connecting piping is provided to connect between the motor housing and the suction port of the compressor body, and a metal pipe is used as at least a part of the connecting piping. With this structure, because the metal pipe has a high thermal conductivity, it is possible to efficiently dissipate heat from the air when flowing through the interior of the metal pipe after being raised in temperature by cooling the brush motor, and hence possible to increase the air compression efficiency of the compressor body.

According to one embodiment of the present invention, an air dryer is provided at the delivery side of the compressor body to dry the gas discharged from the compressor body, and the metal pipe is secured to the outer periphery of the air dryer. With this structure, the metal pipe of the connecting piping can be secured by using the air dryer.

According to one embodiment of the present invention, the connecting piping has the metal pipe, a motor-side universal joint connecting the motor housing and the metal pipe, and a compressor-side universal joint connecting the metal pipe and the suction port of the compressor body. With this structure, because the metal pipe has a high thermal conductivity, it is possible to efficiently dissipate heat from the air when flowing through the interior of the metal pipe after being raised in temperature by cooling the brush motor, and hence possible to increase the air compression efficiency of the compressor body. In addition, the universal joints can suppress the transmission of vibration, which allows an improvement in durability.

According to one embodiment of the present invention, a slight gap is formed between the metal pipe and the outer periphery of the air dryer. With this structure, the gap is so small that a human finger cannot be inserted between the metal pipe and the air dryer. The small gap prevents an individual from holding the metal pipe. Accordingly, it is possible to prevent an individual from carrying the air compressor by holding the connecting piping.

According to one embodiment of the present invention, the compressor body has a crankcase provided with an intake port to take in the atmospheric air as the gas. With this structure, the interior of the compressor body can be cooled by the atmospheric air flowing in from the intake port.

According to one embodiment of the present invention, when air is discharged from an air spring provided between a vehicle body-side member and a wheel-side member of a vehicle, the air is allowed to flow backward through the intake flow path. With this structure, the brush motor and the compressor body can be cooled also when the air is discharged from the air spring.

According to the foregoing embodiments of the present invention, the brushes, which rise in temperature, can be actively cooled, so that it is possible to extend the service life of the brushes and to increase the operating time.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Application No. 2011-018311 filed on Jan. 31, 2011. The entire disclosure of Japanese Patent Application No. 2011-018311 filed on Jan. 31, 2011 including specification, claims, drawings and summary is incorporated herein by reference in its entirety.

The entire disclosure of Japanese Patent Application Public Disclosure No. 2004-60524 including specification, claims, drawings and summary is incorporated herein by reference in its entirety.

What is claimed is:

1. A compressor comprising:
a brush motor having a coil and brushes;
a motor housing accommodating the brush motor;
a reciprocating compressor body in which a crank is rotationally driven by the brush motor to reciprocate a piston in a cylinder, thereby compressing a gas sucked in from a suction port and discharging the gas compressed from a delivery port; and
a gas intake flow path configured such that the gas cools the brushes in the motor housing before cooling the coil and flowing to the suction port.

2. The compressor of claim 1, wherein the motor housing is provided with inlet openings for introducing the gas into the motor housing, and the brushes are secured at respective positions facing the inlet openings.

3. The compressor of claim 2, wherein the inlet openings are provided in a partition between the motor housing and the compressor body.

4. The compressor of claim 2, wherein the inlet openings are provided in the motor housing at a side thereof opposite to a side thereof at which the compressor body is installed.

5. The compressor of claim 1, wherein the gas intake flow path is provided with filters in front of and behind the brushes to trap dust in the gas.

6. The compressor of claim 1, wherein connecting piping is provided to connect between the motor housing and the suction port of the compressor body, and a metal pipe is used as at least a part of the connecting piping.

7. The compressor of claim 6, wherein an air dryer is provided at a delivery side of the compressor body to dry the gas discharged from the compressor body, and the metal pipe is secured to an outer periphery of the air dryer.

8. The compressor of claim 6, wherein the connecting piping has a metal pipe, a motor-side universal joint for connecting the motor housing and the metal pipe, and a compressor-side universal joint for connecting the metal pipe and the suction port of the compressor body.

9. The compressor of claim 7, wherein a slight gap is formed between the metal pipe and the outer periphery of the air dryer.

10. The compressor of claim 1, wherein the compressor body has a crankcase provided with an intake port to take in an atmospheric air as the gas.

11. An air suspension apparatus comprising:
an air spring provided between a vehicle body-side member and a wheel-side member of a vehicle; and
the compressor of claim 1, the compressor being connected to the air spring;
wherein, when air is discharged from the air spring, the air is allowed to flow backward through the intake flow path.

12. An air suspension apparatus comprising:
an air spring provided between a vehicle body-side member and a wheel-side member of a vehicle; and
the compressor of claim 2, the compressor being connected to the air spring;
wherein, when air is discharged from the air spring, the air is allowed to flow backward through the intake flow path.

13. An air suspension apparatus comprising:
an air spring provided between a vehicle body-side member and a wheel-side member of a vehicle; and
the compressor of claim 3, the compressor being connected to the air spring;
wherein, when air is discharged from the air spring, the air is allowed to flow backward through the intake flow path.

14. An air suspension apparatus comprising:
an air spring provided between a vehicle body-side member and a wheel-side member of a vehicle; and
the compressor of claim 4, the compressor being connected to the air spring;
wherein, when air is discharged from the air spring, the air is allowed to flow backward through the intake flow path.

15. An air suspension apparatus comprising:
an air spring provided between a vehicle body-side member and a wheel-side member of a vehicle; and
the compressor of claim 5, the compressor being connected to the air spring;
wherein, when air is discharged from the air spring, the air is allowed to flow backward through the intake flow path.

16. An air suspension apparatus comprising:
an air spring provided between a vehicle body-side member and a wheel-side member of a vehicle; and
the compressor of claim 6, the compressor being connected to the air spring;
wherein, when air is discharged from the air spring, the air is allowed to flow backward through the intake flow path.

17. An air suspension apparatus comprising:
an air spring provided between a vehicle body-side member and a wheel-side member of a vehicle; and
the compressor of claim 7, the compressor being connected to the air spring;
wherein, when air is discharged from the air spring, the air is allowed to flow backward through the intake flow path.

18. An air suspension apparatus comprising:
an air spring provided between a vehicle body-side member and a wheel-side member of a vehicle; and
the compressor of claim 8, the compressor being connected to the air spring;
wherein, when air is discharged from the air spring, the air is allowed to flow backward through the intake flow path.

19. An air suspension apparatus comprising:
an air spring provided between a vehicle body-side member and a wheel-side member of a vehicle; and
the compressor of claim 9, the compressor being connected to the air spring;
wherein, when air is discharged from the air spring, the air is allowed to flow backward through the intake flow path.

20. An air suspension apparatus comprising:
an air spring provided between a vehicle body-side member and a wheel-side member of a vehicle; and
the compressor of claim 10, the compressor being connected to the air spring;
wherein, when air is discharged from the air spring, the air is allowed to flow backward through the intake flow path.
